(19) United States
(12) Patent Application Publication
(10) Pub. No.: US 2024/0051467 A1
(43) Pub. Date: Feb. 15, 2024

(54) STORAGE SPACE ASSEMBLY

(71) Applicant: HBPO GmbH, Lippstadt (DE)

(72) Inventor: Ralf SCHMIDT, Oelde (DE)

(73) Assignee: HBPO GmbH, Lippstadt (DE)

(21) Appl. No.: 18/356,627

(22) Filed: Jul. 21, 2023

(30) Foreign Application Priority Data
Aug. 9, 2022 (DE) 102022120008.6

(51) Int. Cl. B60R 7/04

(52) U.S. Cl. CPC B60R 7/04

(57) ABSTRACT

A storage space assembly having a storage cavity having a space for receiving items to be stored, and a self-driving vehicle including such a storage space assembly. The storage space assembly further has at least one fluid reservoir, in particular a water tank, attached to the storage cavity or integrated into the storage cavity.

### CROSS REFERENCE TO RELATED APPLICATIONS

This patent application claims priority on and the benefit of German Patent Application No. 10 2022 120 008.6 having a filing date of 9 Aug. 2022.

### BACKGROUND OF THE INVENTION

### Technical Field

The invention relates to a storage space assembly.

### Prior Art

Such storage space assemblies are used in motor vehicles. With the increasing electrification of vehicles, more storage space is being made available in the frontal region of vehicles as a result of engine components being dispensed with. Storage cavities are thus increasingly used in this region for stowing items to be stored.

In addition to electrification, the development of self-driving vehicles also increasingly has a part to play. Here, sensors are used which have to be kept functional during the entire operation of the vehicle for understandable reasons regarding safety. Pollutants can mean that the operational safety of the corresponding sensor system cannot always be assured. Whereas, in non-self-driving vehicles, the wash fluid for cleaning the windscreen, for example, can be refilled by the driver if no more is present, in self-driving vehicles, malfunctions and, whilst in operation, accidents can be caused when sensors do not function or do not function properly because of pollutants. In the case of conventional fluid storage for cleaning fluids, there is a risk that the cleaning fluids stored therein are used up too quickly.

There is therefore an increased demand for the storage of cleaning fluids in self-driving vehicles, but also in conventional vehicles.

### BRIEF SUMMARY OF THE INVENTION

The object of the present invention is to eliminate the aforementioned disadvantages.

This object is achieved by a storage space assembly comprising a storage cavity having a space for receiving items to be stored, the storage space assembly further comprising at least one fluid reservoir, in particular a water tank, which is attached to the storage cavity or integrated into the storage cavity. Advantageous embodiments can be found in the dependent claims.

The storage space assembly according to the invention comprises a storage cavity having a space for receiving items to be stored. In this case, the storage space assembly further comprises at least one fluid reservoir which is attached to the storage cavity or integrated into said storage cavity. In this way, the fluid reservoir is assigned to a component, specifically the storage cavity, which already has a certain size. Due to the large surface area of the storage cavity, this already large surface can be used to form a doubled base or doubled surface thereon and to produce a volume above this surface, which then forms the fluid reservoir. The fluid reservoir is preferably a water tank, e.g., for cleaning agents for the window panes and sensors of a vehicle. According to the invention, a sufficient amount of water for cleaning the sensor system can thus also be provided in self-driving vehicles. Compared with conventional main headlight cleaning systems or water which is made available for cleaning window panes, the volume of the fluid reservoir is greatly increased. In this way, more cleaning fluid can thus be made available, so that, for example, it can be ensured, even in self-driving vehicles, that cleaning fluids can be provided in the order of magnitude of approximately 20 l for cleaning the sensors, laser scanners or cameras. This is not possible in conventional cleaning operation, since such additional volumes cannot be easily accommodated in the installation space available.

As a result of the integrative approach according to the invention, there is consequently hardly any need for any additional installation space, since the fluid reservoir is placed on or integrated into pre-existing components, specifically storage cavities.

Different manufacturing methods or manufacturing techniques can be used when securing or integrating the fluid reservoir. For example, blow mold components can be used, which can be secured to the storage cavity by means of clips, screws, or form-fitting connection. It is also conceivable for the fluid reservoir to be formed during production as a half shell which is joined to the storage cavity. This can take place, for example, by means of a welding process, for example an ultrasonic welding process, a vibration friction welding process, or the like, or by means of a sealing adhesive process. It is also conceivable to design the entire storage space assembly as a blow mold component or HDPE component. In this way, the cavity is directly produced. Something similar can be achieved by a molding process.

The fluid reservoir can comprise a fluid inlet for filling and a fluid outlet for emptying.

Furthermore, the fluid reservoir can be arranged between an inner wall facing the receiving space and an outer wall of the storage cavity. In this embodiment, the storage cavity and the fluid reservoir can therefore be produced as one piece.

As an alternative or in addition thereto, the fluid reservoir can be integrally formed on the storage cavity. Therefore, in some circumstances, a fluid reservoir can be added to existing storage cavities. In order to keep the installation space generally low, the fluid reservoir can, for example, be distributed over a part of the wall. This permits a relatively flat design of the fluid reservoir, such that it creates no lateral protrusions or only slight lateral protrusions beyond the wall of the storage cavity. For this purpose, the fluid reservoir can preferably extend over at least a part, in particular between 40% and 80%, of the wall of the storage cavity. Of course, the fluid container can also extend over more than 80%, even over 100%, of the wall of the storage cavity. In the surface extension mentioned in the above examples, the fluid reservoir can be designed so as to be relatively flat and nevertheless still hold a sufficiently large volume of fluid.

For reasons of weight, the fluid reservoir and/or the storage cavity is/are preferably made of a plastics material or comprise(s) such a plastics material. In this case, the material for the fluid reservoir and/or the storage cavity can comprise or be HDPE, PP or PA. Of course, other materials are also possible. In particular, combinations of said materials and additional reinforcements can be present. For example, said material can also or additionally comprise a glass fiber material, and in particular can be filled therewith.

In general, it is possible to form the fluid reservoir in the region of the wall of the storage cavity or as part of the same. According to another embodiment, the fluid reservoir can alternatively or additionally be arranged below a base of the storage cavity. This can be achieved either by a type of doubled base within which the fluid reservoir is arranged, or by a separate fluid reservoir arranged below the base of the storage cavity.

Furthermore, the invention relates to a self-driving vehicle which comprises a storage space assembly described above.

### BRIEF DESCRIPTION OF THE DRAWINGS

The invention is explained in more detail below with reference to the embodiments illustrated in FIGS. 1 to 5.

FIG. 1 shows a first embodiment of the storage space assembly according to the invention in a perspective view.

FIG. 2 is a schematic cross-sectional view through the embodiment shown in FIG. 1.

FIG. 3 is a view of a second embodiment of the storage space assembly according to the invention.

FIG. 4 is a schematic cross-sectional view of the embodiment shown in FIG. 3.

FIG. 5 shows a third embodiment of the storage space assembly according to the invention in a cross-sectional view.

### DETAILED DESCRIPTION OF PREFERRED EMBODIMENTS

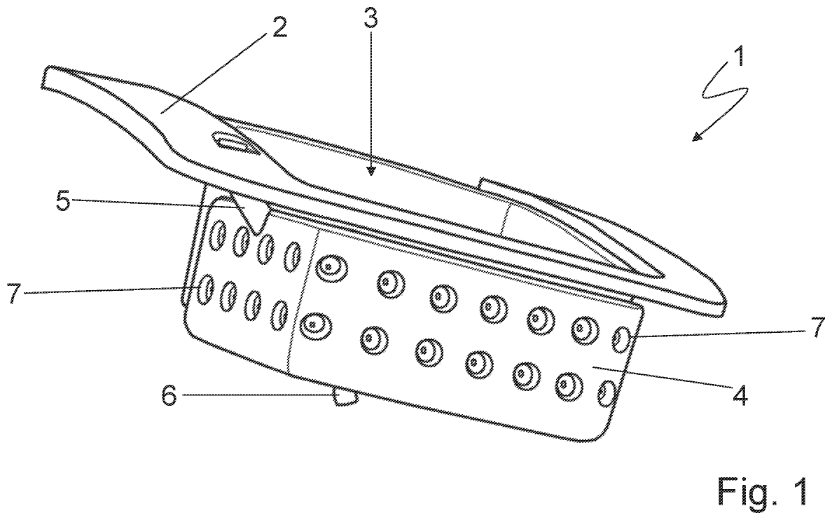

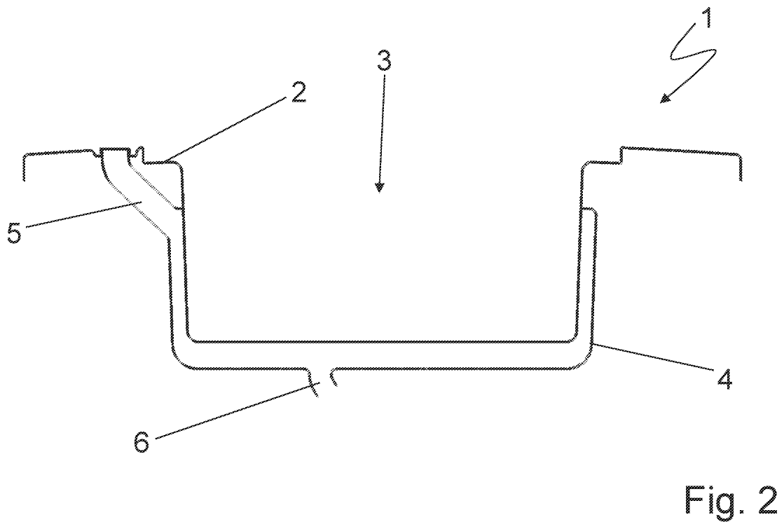

The storage space assembly 1 shown in FIG. 1 and FIG. 2 has a storage cavity 2 that provides a storage space 3. In the example shown, a fluid reservoir 4 is formed on the wall of the storage cavity 2. In the example shown, this is done by attaching a half shell 4 to the wall of the storage cavity 2. Depressions 7 are formed in the half shell 4, which, on the one hand, are used to secure the fluid reservoir 4 to the storage cavity 2, by, for example, it being possible to provide screw connections or welded connections there. On the other hand, these depressions 7 also have a stiffening effect similar to that of beading or the like.

The fluid reservoir 4 can be filled from a fluid inlet 5 which is accessible from the upper edge of the storage cavity 2. For emptying, a fluid outlet 6 is used at the lower edge of the fluid reservoir 4.

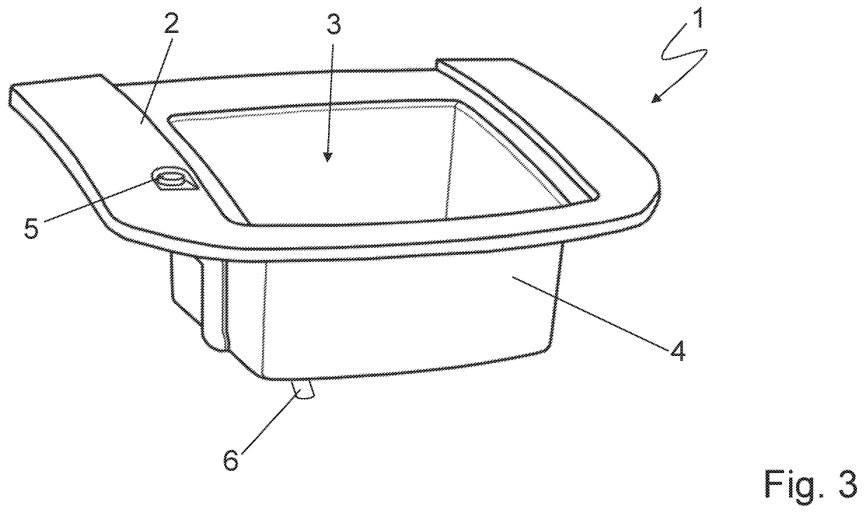

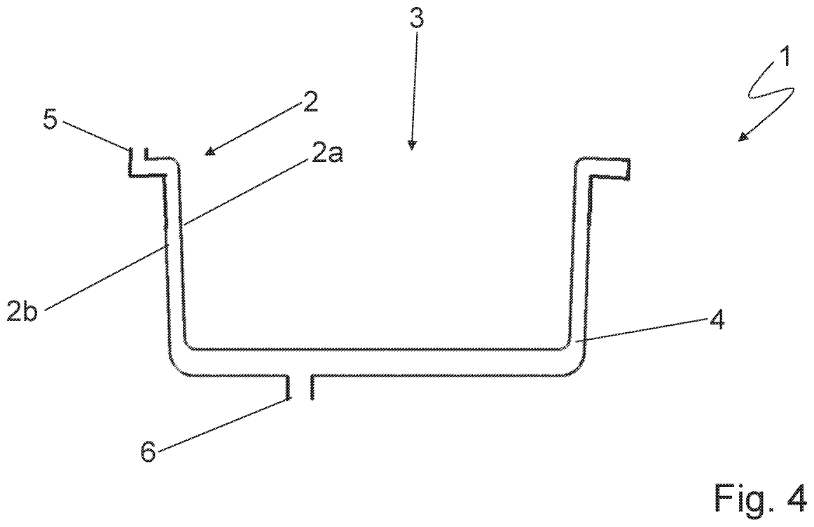

FIGS. 3 and 4 show an alternative embodiment of the storage space assembly 1, and, in this embodiment, the fluid reservoir 4 is integrally formed with the storage cavity 2. As can be seen in particular from the cross section in FIG. 4, the fluid reservoir 4 is formed between the inner wall 2a and the outer wall 2b of the storage cavity 2.

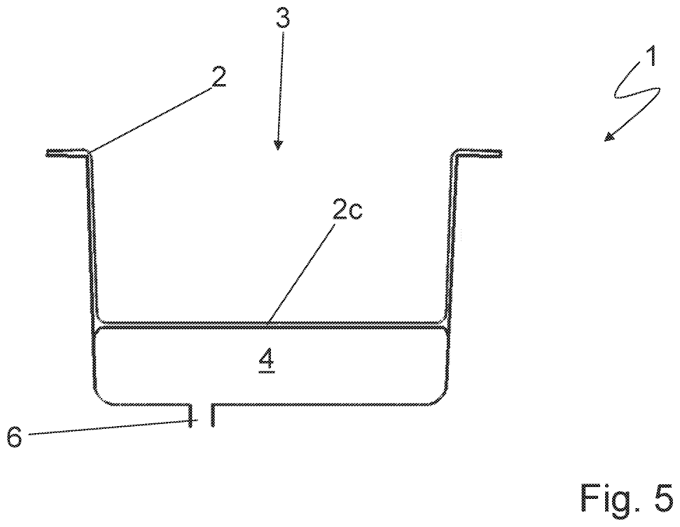

In a further embodiment, which is shown in FIG. 5, the fluid reservoir 4 is arranged below the storage cavity 2, more precisely below its base 2c. Here too, as with the doubled wall structure of the preceding embodiments, there is in principle the possibility of a doubled base within which the fluid reservoir 4 can be formed. However, it is equally possible to simply arrange the fluid reservoir 4 as a separate component below the base of the storage cavity 2, to integrally form it on the storage cavity 2 or to connect it in another way to said storage cavity.

What is claimed is:

1. A storage space assembly (1) comprising a storage cavity (2) having a space (3) for receiving items to be stored, the storage space assembly (1) further comprising at least one fluid reservoir (4) which is attached to the storage cavity (2) or integrated into the storage cavity (2).

2. The storage space assembly (1) according to claim 1, wherein the fluid reservoir (4) is arranged between an inner wall (2a) facing the receiving space (3) and an outer wall (2b) of the storage cavity (2).

3. The storage space assembly (1) according to claim 1, wherein the fluid reservoir (4) is integrally formed on the storage cavity (2).

4. The storage space assembly (1) according to claim 1, wherein the fluid reservoir (4) and/or the storage cavity (2) is/are made of a plastics material or comprise(s) such a plastics material.

5. The storage space assembly (1) according to claim 1, wherein the fluid reservoir (4) is arranged below a base (2c) of the storage cavity (2).

6. The storage space assembly (1) according to claim 1, wherein the fluid reservoir (4) comprises a fluid inlet (5) and a fluid outlet (6).

7. The storage space assembly (1) according to claim 1, wherein the fluid reservoir (4) extends over at least a part of the wall of the storage cavity (2).

8. The storage space assembly (1) according to claim 1, wherein the material for the fluid reservoir (4) and/or the storage cavity (2) comprises or is HDPE, PP or PA.

9. The storage space assembly (1) according to claim 8, wherein the material comprises a glass fiber material.

10. The storage space assembly (1) according to claim 1, wherein the at least one fluid reservoir (4) is a water tank.

11. The storage space assembly (1) according to claim 7, wherein the fluid reservoir (4) extends over between 40% and 80% of the wall of the storage cavity (2).

12. The storage space assembly (1) according to claim 9, wherein the material is filled with the glass fiber material.

13. A self-driving vehicle comprising a storage space assembly (1), the storage space assembly (1) comprising a storage cavity (2) having a space (3) for receiving items to be stored, the storage space assembly (1) further comprising at least one fluid reservoir (4) which is attached to the storage cavity (2) or integrated into the storage cavity (2).

14. The self-driving vehicle according to claim 13, wherein the fluid reservoir (4) is arranged between an inner wall (2a) facing the receiving space (3) and an outer wall (2b) of the storage cavity (2).

15. The self-driving vehicle according to claim 13, wherein the fluid reservoir (4) is integrally formed on the storage cavity (2).

16. The self-driving vehicle according to claim 13, wherein the fluid reservoir (4) and/or the storage cavity (2) is/are made of a plastics material or comprise(s) such a plastics material.

17. The self-driving vehicle according to claim 13, wherein the fluid reservoir (4) is arranged below a base (2c) of the storage cavity (2).

18. The self-driving vehicle according to claim 13, wherein the fluid reservoir (4) comprises a fluid inlet (5) and a fluid outlet (6).

19. The self-driving vehicle according to claim 13, wherein the fluid reservoir (4) extends over at least a part of the wall of the storage cavity (2).

20. The self-driving vehicle according to claim 13, wherein the at least one fluid reservoir (4) is a water tank.
